(19) United States
(12) Patent Application Publication
(10) Pub. No.: US 2026/0314604 A1
(43) Pub. Date: Oct. 15, 2026

(54) BIOCHARS DERIVED FROM PLUM BIOMASS

(71) Applicant: TEXAS STATE UNIVERSITY, San Marcos, TX (US)

(72) Inventor: Sujata Mandal, San Marcos, TX (US)

(73) Assignee: TEXAS STATE UNIVERSITY, San Marcos, TX (US)

(21) Appl. No.: 19/570,686

(22) Filed: Mar. 18, 2026

Related U.S. Application Data
(60) Provisional application No. 63/774,051, filed on Mar. 18, 2025.

(51) Int. Cl. A01N 65/34; A01N 59/00; A01P 21/00; C02F 1/28; C02F 101/20; C02F 101/30

(52) U.S. Cl. CPC A01N 65/34; A01N 59/00; A01P 21/00; C02F 1/283; C02F 2101/20; C02F 2101/308

(57) ABSTRACT

The invention relates to a biochar derived from plum biomass. The biochars may also be loaded with one or more nutrients. The invention also relates to methods of maintaining or enhancing the growth of a plant or seed by exposing a growth environment of the plant or seed to a biochar derived from plum biomass. The invention also relates to methods of removing contaminants from an environment by exposing the environment to a biochar derived from plum biomass. Additionally, the invention relates to methods of making biochars by pyrolyzing a plum biomass to form the biochar.

### CROSS-REFERENCE TO RELATED APPLICATIONS

This application claims priority to U.S. Provisional Patent Application No. 63/774,051, filed on Mar. 18, 2025. The entirety of the aforementioned application is incorporated herein by reference.

### BACKGROUND

A need exists for the production of more stable and effective biochars for various applications, such as crop growth and environmental remediation. Numerous embodiments of the present disclosure aim to address the aforementioned need.

### SUMMARY

In some embodiments, the present disclosure pertains to biochars. In some embodiments, the biochars of the present disclosure are derived from plum biomass. In some embodiments, the plum biomass includes plum pit. In some embodiments, the biochars of the present disclosure are loaded with one or more nutrients.

Additional embodiments of the present disclosure pertain to methods of maintaining or enhancing the growth of a plant or seed by exposing a growth environment of the plant or seed to the biochars of the present disclosure. Further embodiments of the present disclosure pertain to methods of removing contaminants from an environment by exposing the environment to the biochars of the present disclosure. Additional embodiments of the present disclosure pertain to methods of making the biochars of the present disclosure by pyrolyzing plum biomass to form the biochars.

### BRIEF DESCRIPTION OF THE DRAWINGS

FIG. 1A provides a scanning electron microscopy with energy-dispersive X-ray spectroscopy (SEM-EDAX) image of plum biomass (PBM) at 1000× magnification.

FIG. 1B provides an SEM-EDAX image of plum biochar (PBC) at 1000× magnification.

FIG. 1C provides a scanning electron microscopy (SEM) image of PBC at 1000× magnification after adsorption of Congo red (CR), Crystal violet (CV) and Malachite green (MG) dyes.

FIG. 2 provides a Fourier-transform infrared (FTIR) of PBC and PBM.

FIG. 3 provides a comparative adsorption study of the performance of commercial activated carbon (CAC) and PBC for the remediation of CR, CV and MG dye solutions. The contact time was 20 minutes and the concentration of dye solutions was 10 ppm.

FIG. 4A provides an ultraviolet-visible (UV-Vis) spectroscopy of an MG-PBC contact time study. The study took place for 20 minutes, 1 hour, and 2 hours.

FIG. 4B provides a UV-Vis spectroscopy of a CV-PBC contact time study. The study took place for 20 minutes, 1 hour, and 2 hours.

FIG. 4C provides a UV-Vis spectroscopy of a CR-PBC contact time study. The study took place for 20 minutes, 1 hour, and 2 hours.

FIGS. 5A-5B provide chickpea germination studies in the presence of PBC and various dyes (CV, MG, and CR). Shown are the results of the germination studies at day 1 (FIG. 5A) and day 14 (FIG. 5B).

FIGS. 6A-6C provide mung bean (lentil) germination studies in the presence of PBC and various dyes (CV, MG, and CR). Shown are the results of the germination studies at day 1 (FIG. 6A) and day 8 (FIG. 6B). Also shown are the images of the roots and shoots of the grown plants (FIG. 6C).

FIGS. 7A-7D provide images of lentil plants grown in the presence of manganese-infused PBCs. Shown are growth after the 7th day (FIGS. 7A and 7C) and the 10th day (FIGS. 7B and 7D).

### DETAILED DESCRIPTION

It is to be understood that both the foregoing general description and the following detailed description are illustrative and explanatory, and are not restrictive of the subject matter, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that include more than one unit unless specifically stated otherwise.

The section headings used herein are for organizational purposes and are not to be construed as limiting the subject matter described. All documents, or portions of documents, cited in this application, including, but not limited to, patents, patent applications, articles, books, and treatises, are hereby expressly incorporated herein by reference in their entirety for any purpose. In the event that one or more of the incorporated literature and similar materials defines a term in a manner that contradicts the definition of that term in this application, this application controls.

Biochar is a stable solid, rich in carbon, that is made from organic waste material (e.g., agricultural waste) or biomass (e.g., forestry waste) that is partially combusted in the presence of limited oxygen through the process of pyrolysis at temperatures ranging from ~500° C. to 800° C. Biochar is a porous (e.g., 58%-80%), high total pore volume (e.g., 1.3-3.7 cm³/g), and high surface area (e.g., 250 m²/g or greater than 500 m²/g) material.

As a result of biochar's structure and properties, it represents a renewable material that has seen applications as an absorbent to remove pollutants from wastewater and water streams, and as a soil amendment that can help retain water and nutrients in the soil for plants to take up as they grow. In addition, biochar can be used to remove various types of dyes and pigments during textile production, can remove organic dyes from wastewater streams, and can eliminate dyes from industrial effluents. Due to their high adsorption capability, some biochars have the potential to sequester heavy metals (e.g., Cr, Cd, Cu, As, Pb, Zn, Ni, Mn) from soils, remove pesticides from soils, capture hormones from soils, prevent nitrate leaching and fecal bacteria from entering into waterways, and reduce GHG emissions from soils as biochar captures the carbon in the soil.

Biochar has also emerged as a promising fruit waste management system. In particular, a need exists for managing an increasing amount of fruit waste in a sustainable way while mitigating the effects of climate change. Among other biomass waste sources, fruit-based biomass wastes are on the rise due to global food and fruit demand. Processing fruits and vegetables generate significant amounts of waste. As such, the utilization of fruit wastes for the development of biosorbents have received high attention due to their low cost and bio cellulose abundance.

Moreover, fruit waste utilization enhances recycling of waste, which is available at zero cost and promotes circular economy and carbon neutrality towards a sustainable environment. In recent times, researchers have used orange peel, coconut shells, litchi peels, jackfruit seeds, mango leaves, avocado kernel seeds, papaya seeds, and custard apple peel for producing biochar or activated carbon.

However, the use of biochar for the aforementioned purposes is currently limited by biochar's instability and degradation. Additional limitations of biochar include unpredictable effects on soil flora, fauna, and plant growth.

As such, there is a need to produce more stable and beneficial biochars for various applications. Such applications include environmental remediation, improving water quality, enhancing soil health, restoring soil functions, supporting sustainable land management, and managing fruit waste. Numerous embodiments of the present disclosure aim to address the aforementioned limitations.

In some embodiments, the present disclosure pertains to biochars. In some embodiments, the biochars of the present disclosure are derived from plum biomass. Additional embodiments of the present disclosure pertain to methods of maintaining or enhancing the growth of a plant or seed by exposing a growth environment of the plant or seed to the biochars of the present disclosure. Further embodiments of the present disclosure pertain to methods of removing contaminants from an environment by exposing the environment to the biochars of the present disclosure. In some of such embodiments, the biochars of the present disclosure absorb the contaminants in the environment. Additional embodiments of the present disclosure pertain to methods of making the biochars of the present disclosure. In some embodiments, such methods include pyrolyzing plum biomass to form the biochars. As set forth in more detail herein, the present disclosure can have numerous embodiments.

Plum Biomasses and their Pyrolysis

In some embodiments, the biochars of the present disclosure may be derived from plum biomasses. Additionally, the biochar formation methods of the present disclosure may include the pyrolysis of plum biomasses.

Biochars may be derived from various plum biomasses. For instance, in some embodiments, the plum biomass includes, without limitation, plum pits, plum peels, plum stones, plum pomace, or combinations thereof. In some embodiments, the plum biomass includes plum pits.

Pyrolysis, a thermochemical decomposition of biomass usually takes place at medium (300-800° C.) to high temperatures (800-1300° C.) in the absence of oxygen. Several factors influence the physicochemical properties of biochar, including feedstock, temperature, heating rate, residence time, and atmosphere.

Plum biomass may be pyrolyzed under various conditions. For instance, in some embodiments, pyrolysis is conducted at temperatures between 300° C. and 1,300° C. In some embodiments, pyrolysis is conducted at temperatures between 300° C. and 700° C. In some embodiments, pyrolysis is conducted at temperatures between 500° C. and 800° C. In some embodiments, pyrolysis is conducted at temperatures between 500° C. and 600° C. In some embodiments, pyrolysis is conducted at 500° C. In some embodiments, pyrolysis is conducted at temperatures of less than 600° C.

In some embodiments, pyrolysis may occur in the presence of oxygen. In some embodiments, pyrolysis may occur in the absence of oxygen. In some embodiments, oxygen-limited pyrolysis is conducted at temperatures between 300° C. and 700° C.

Pyrolysis may be conducted at various heating rates. For instance, in some embodiments, the pyrolysis is conducted at a heating rate between 1° C./min and 50° C./min. In some embodiments, the pyrolysis is conducted at a heating rate between 1° C./min and 25° C./min. In some embodiments, the pyrolysis is conducted at a heating rate between 1° C./min and 10° C./min. In some embodiments, the pyrolysis is conducted at a heating rate of at least 5° C./min. In some embodiments, the pyrolysis is conducted at a heating rate of at least 10° C./min. In some embodiments, the pyrolysis is conducted at a heating rate of 10° C./min. In some embodiments, pyrolysis is conducted at heating rates of 10° C./second to 200° C./second.

Pyrolysis may be conducted for various periods of time. For instance, in some embodiments, pyrolysis is conducted for 1 hour to 3 hours. In some embodiments, pyrolysis is conducted for 1 hour to 2 hours. In some embodiments, pyrolysis is conducted for at least 1 hour.

In some embodiments, the biochar formation methods of the present disclosure also include one or more pre-treatment steps of the plum biomass. For instance, in some embodiments, the biochar formation methods of the present disclosure also include a step of washing a plum biomass prior to pyrolysis. In some embodiments, the biochar formation methods of the present disclosure also include a step of drying the plum biomass prior to pyrolysis. In some embodiments, the biochar formation methods of the present disclosure also include a step of breaking or grinding a plum biomass prior to pyrolysis. In some embodiments, the biochar formation methods of the present disclosure also include a step of treating a plum biomass with lemon juice prior to pyrolysis.

### Biochar Properties

Pyrolysis aids in increasing the specific surface area of biochars by the formation of micropores in the biochars. By setting optimal parameters, such as high heating rates (e.g., 10° C./min), pyrolysis temperatures (e.g., ~500° C.), and less residence time, the feedstock can be heated to produce desired products. For the formation of biochar, pyrolysis temperature may have the most significant effect, followed by pyrolysis heating rate.

The biochars of the present disclosure can have various advantageous properties. For instance, in some embodiments, the biochars of the present disclosure include internal pore diameters greater than 2 micrometers. In some embodiments, the internal pore diameters of the biochars of the present disclosure range from 2 micrometers to 5 micrometers. In some embodiments, the internal pore diameters of the biochars of the present disclosure range from 2 micrometers to 20 micrometers.

The biochars of the present disclosure can have various particle diameters. For instance, in some embodiments, the biochars of the present disclosure have a particle diameter between 100 micrometers and 500 micrometers. In some embodiments, the biochars of the present disclosure have a particle diameter between 200 micrometers and 300 micrometers. In some embodiments, the biochars of the present disclosure have a particle diameter between 230 micrometers and 300 micrometers. In some embodiments, the biochars of the present disclosure have a plurality of micropores.

In some embodiments, the biochar formation methods of the present disclosure also include a step of standardizing a particle diameter of the formed biochars. In some embodiments, the standardizing includes sieving. In some embodiments, the particle diameter of the biochars of the present disclosure are standardized to the aforementioned diameters.

The biochars of the present disclosure can include various amounts of carbon. For instance, in some embodiments, the biochars of the present disclosure include 70 wt % to 85 wt % carbon. In some embodiments, the biochars of the present disclosure include at least 75 wt % carbon. In some embodiments, the biochars of the present disclosure include 77.8 wt % carbon.

The biochars of the present disclosure can include various amounts of oxygen. For instance, in some embodiments, the biochars of the present disclosure include 15 wt % to 25 wt % oxygen. In some embodiments, the biochars of the present disclosure include at least 20 wt % oxygen. In some embodiments, the biochars of the present disclosure include 21.8 wt % oxygen.

In some embodiments, the major constituents of plum biomass (C, H and O) volatilize during dehydration and pyrolysis. In some embodiments, the proportion of C in the solid phase increases from about 40 to 50 percent by weight in the feedstock to on the order of 70 to 80 percent by weight after pyrolysis between 250° C. and 600° C. In some embodiments, carbonization further increases the C content to more than 90 percent by weight in some of the cases.

The biochars of the present disclosure can have various levels of porosity. For instance, in some embodiments, the biochars of the present disclosure have a porosity of at least 50%. In some embodiments, the biochars of the present disclosure have a porosity of 50% to 80%. In some embodiments, the biochars of the present disclosure have a porosity of 58% to 80%.

The biochars of the present disclosure can have various amounts of total pore volume. For instance, in some embodiments, the biochars of the present disclosure have a total pore volume of at least 1 cm³/g. In some embodiments, the biochars of the present disclosure have a total pore volume between 1 cm³/g and 4 cm³/g. In some embodiments, the biochars of the present disclosure have a total pore volume between 1.3 cm³/g and 3.7 cm³/g.

The biochars of the present disclosure can have various surface areas. For instance, in some embodiments, the biochars of the present disclosure have a surface area at least 250 m²/g. In some embodiments, the biochars of the present disclosure have a surface area between 250 m²/g and 500 m²/g.

The biochars of the present disclosure can include various functional groups. For instance, in some embodiments, the functional groups include, without limitation, hydroxyl groups, carbonyl groups, olefinic groups, aldehyde groups, ketone groups, ester groups, aromatic groups, or combinations thereof.

In some embodiments, the biochars of the present disclosure are loaded with one or more nutrients. In some embodiments, the biochar formation methods of the present disclosure also include a step of loading the biochar with one or more nutrients. In some embodiments, the nutrients include, without limitation, manganese, nitrogen, phosphorus, potassium, calcium, magnesium, iron, zinc, copper, boron, molybdenum, or combinations thereof. In some embodiments, the nutrients assist in the symbiotic fixation of atmospheric N₂ in agricultural soils, photosynthesis and plant growth.

### Exposure of Biochars to Environments

The methods of the present disclosure may expose the biochars of the present disclosure to plant and seed growth environments in various manners. Similarly, the methods of the present disclosure may expose the biochars of the present disclosure to contaminated environments in various manners. For instance, in some embodiments, the exposure occurs by a method that includes, without limitation, spraying, incubating, mixing, pouring, irrigating, or combinations thereof.

### Growth Environments

The biochars of the present disclosure may be exposed to various plant and seed growth environments. For instance, in some embodiments, the growth environment includes, without limitation, water, soil, a hydroponic solution, or combinations thereof.

In some embodiments, the growth environment is irrigated with water. In some embodiments, the water includes the biochars of the present disclosure.

### Environments for Contaminant Removal

The methods and biochars of the present disclosure may be utilized to remove contaminants from various environments. For instance, in some embodiments, the environment includes, without limitation, an aqueous environment, a gaseous environment, a solid environment, or combinations thereof. In some embodiments, the environment includes an aqueous environment.

In some embodiments, the aqueous environment includes, without limitation, water, wastewater, water streams, industrial effluents, or combinations thereof.

In some embodiments, the environment includes soil. In some embodiments, the environment includes air. In some embodiments, the environment includes a surface.

### Contaminants

In some embodiments, the plant and seed growth environments of the present disclosure may include one or more contaminants. In some of such embodiments, the biochars of the present disclosure may be utilized to absorb the contaminants and thereby enhance the growth of plants and seeds. Additionally, the biochars and methods of the present disclosure may be utilized to absorb various contaminants from various environments.

For instance, in some embodiments, the contaminants include, without limitation, dyes, metals, organic pollutants, hormones, carbon dioxide, or combinations thereof. In some embodiments, the contaminants include dyes. In some embodiments, the dyes include, without limitation, Crystal Violet (CV), Malachite Green (MG), Congo Red (CR), or combinations thereof.

In some embodiments, the contaminants include metals. In some embodiments, the metals include, without limitation, chromium, cadmium, copper, arsenic, lead, zinc, nickel, manganese, or combinations thereof.

In some embodiments, the contaminants include organic pollutants. In some embodiments, the organic pollutants include, without limitation, heavy metals, pesticides, phenols, pharmaceuticals, drugs, hormones, hydrocarbons, volatile organic compounds, industrial dyes, or combinations thereof.

The methods and biochars of the present disclosure may be utilized to remove various amounts of contaminants from an environment. For instance, in some embodiments, the biochar removes at least 70% of contaminants from an environment. In some embodiments, the biochar removes at least 75% of contaminants from an environment. In some embodiments, the biochar removes at least 80% of contaminants from an environment. In some embodiments, the biochar removes at least 85% of contaminants from an environment. In some embodiments, the biochar removes at least 90% of contaminants from an environment. In some embodiments, the biochar removes at least 95% of contaminants from an environment.

The contaminant removal methods of the present disclosure can have various applications. For instance, in some embodiments, the biochars and methods of the present disclosure may be used for environmental remediation, improving water quality, enhancing soil health, restoring soil function, retention of soil moisture, stabilization of soil pH, facilitation of microbial activities, supporting sustainable land management, managing fruit waste, or combinations thereof.

### Plants and Seeds

The methods and biochars of the present disclosure may be utilized to maintain or enhance the growth of various plants and seeds. For instance, in some embodiments, the plant or seed includes a seed. In some embodiments, the plant or seed includes a plant.

In some embodiments, the plant or seed includes, without limitation, cereals, legumes, oilseeds, fruits, vegetables, crops, or combinations thereof. In some embodiments, the plant or seed includes, without limitation, peas, chickpeas, beans, mung beans, tomatoes, potatoes, wheat, rice, corn, barley, oats, sorghum, millet, rye, lentils, soybeans, faba bean, poplar trees, apple trees, conifers, or combinations thereof.

### Effects of Biochars on Plants and Seeds

The biochars of the present disclosure can have various effects on plants and seeds. For instance, in some embodiments, the biochars of the present disclosure can absorb contaminants and thereby prevent harm to plants and seeds. In some embodiments, the biochars of the present disclosure enhance the germination rate of a seed. In some embodiments, the biochars of the present disclosure enhance the growth rate of a plant. In some embodiments, the biochars of the present disclosure enhance leaf greenness of a plant.

In some embodiments, the biochars of the present disclosure may be loaded with one or more nutrients. In some of such embodiments, the biochars of the present disclosure release the nutrients to the plant or seed. In some of such embodiments, the biochars of the present disclosure provide sustained release of the nutrients and thereby maintain or enhance the growth of plants and seeds.

### Additional Embodiments

Reference will now be made to more specific embodiments of the present disclosure and experimental results that provide support for such embodiments. However, Applicant notes that the disclosure herein is for illustrative purposes only and is not intended to limit the scope of the claimed subject matter in any way.

### Example 1. Production and Use of Biochar Derived from Plum Pits

In this Example, plum pit biochar (plum biochar or PBC) was selected as an abundant and low-cost precursor for the preparation of a potential absorbent. This Example adds value to the utilization of unused waste by recycling it for environmental remediation, thereby reducing waste and promoting sustainability. Reusing waste materials for the purification of wastewater not only reduces the demand for virgin resources but also minimizes the generation of additional waste.

Additionally, the usage of sustainable biochar in soil amendment is also established. The novel biochar was prepared without using any chemical reagents through the direct pyrolysis of palm pit at 500° C. for 1 h only and was used for the first time for the remediation of three sets of dyes (i.e., anionic dyes (i.e., Congo red) and cationic dyes (i.e., Crystal violet and Malachite green)) from aqueous media.

Moreover, the efficacy of the fabricated absorbent was systematically investigated on seed germination of chickpea seeds (Cicer arietinum), an annual legume of the family Fabaceae using simultaneously treated and untreated water contaminated with three set of dye solutions. These legumes are drought-resistant, require few inputs and fix nitrogen in the soil. To check the efficacy of the prepared biochar (PBC), Applicant also investigated the growth of seeds to seedling using mung beans (Vigna radiata L.).

### Example 1.1. Chemical Reagents

All chemicals and reagents used in this Example were of analytical grade. Distilled water was used for the preparation of all aqueous solutions throughout the experiment. All three dyes (Crystal Violet (CV), Malachite green (MG), and Congo Red (CR)), HCl (≥99% purity), and NaOH (≥99% purity) were procured from Sigma-Aldrich Co. (MO, USA) and utilized without additional purification.

### Example 1.2. Biochar Preparation

Plum pits were collected from local stores and were washed several times with tap water and then with distilled water for elimination of dust particles. Next, plum pits were kept under sunlight for two weeks to eliminate moisture and then broken into small pieces with stainless steel electronic grinding machines. The crushed plum pits were treated with 2 ml of lemon juice and then dried at room temperature for 2-3 days followed by oven drying at 50° C. for an hour. The dried plum pit was pyrolyzed at 500° C. (heating rate: 10° C. min⁻¹) for 1 h by using an MTI OTF-1200× Open Tube Furnace (Morgan Hill, CA).

After the preparation of plum biochar, the absorbent was labelled as PBC. Applicant standardized PBC particle diameter (230-300 μm) by a sieving process that utilized different sieves. The PBC was kept in an airtight container until use.

### Example 1.3. Adsorption Experiments

The batch adsorption experiments were employed in triplicate to minimize error in analysis caused by UV Vis spectrophotometer signal variation, dose or amount of biochar temporarily removed between samplings. A stock solution of 1,000 mg/L CV, MG, and CR were prepared by the dissolution of 1 g of dye with 1 L of distilled water in a volumetric flask. The stock solution was stored in a dark container at 4° C. for further use. The stock solution was further diluted to achieve desired concentrations ranging from 10-50 mg/L. The pH values of the solutions were adjusted and maintained throughout the experiment using 0.1 M HCl and 0.1 M NaOH, facilitated by a pH meter (Hach HQ440D multi-meter). The adsorption behavior of PBC absorbent toward CV, MG, and CR dye was studied using the batch equilibrium technique under the influence of various experimental controlling parameters, such as pH, initial, dye concentration, contact time, and temperature.

A set of Erlenmeyer flasks (300 ml) containing 200 ml of different concentrations of CV, MG, and CR dyes solution and 50 mg of biochar was shaken at 200 rpm, at a temperature of 25±2° C., and at a pH of 6.5±0.5 for a certain time (20, 40, 60, 80, 100, and 120 minutes and 24 hours). The concentrations of CV, MG, and CR were measured using a UV-Vis Spectrophotometer (Thermos scientific Model No. GENESYS 180) at 592 nm, 618 nm, and 496 nm respectively using a 3.5 mL quartz cuvette with a 1 cm³ path length.

To explore the effect of contact time of absorbate with absorbent, 20 mg of PBC was added to conical flasks containing 200 mL of the dye solutions, shaken at 200 rpm with initial concentrations of CV, MG, and CR dye solutions, at a pH of 6.5±0.5 for different time periods (20-120 min) at 25±2° C. After each treatment, the dye samples were withdrawn, centrifuged, and diluted. The change in the concentrations of CV, MG, and CR was monitored by an ultraviolet-visible (UV-Vis) spectrophotometer at a λ max of each dye (CV λ max=592 nm, MG λ max=618 nm, and CR λ max=496 nm).

The adsorption capacities (mg g⁻¹) of CV, MG, and CR dye solutions onto fabricated biochar, at time t (qt) and at equilibrium (qe), were calculated using Equations 1 and 2 as follows:

$$qe = \frac{( Ci - Ce ) \times V}{M} \qquad Equation 1$$

$$qt = \frac{( Ci - Ct ) \times V}{M} \qquad Equation 2$$

In Equations 1 and 2, Ci=the initial concentrations of CV, MG and CR solutions in mg L⁻¹; Ct=the concentration of CV, MG and CR in mg L⁻¹ at time t; V=volume of CV, MG, and CR in L; M=mass of PBC (g); and Ce=the concentration of CV, MG and CR at equilibrium. The removal percentage (R %) of the pollutant was calculated using Equation 3.

$$R \% = \frac{( Ci - Ce )}{( Ci )} \times 100 \qquad Equation 3$$

### Example 1.4. Characterization of PBC

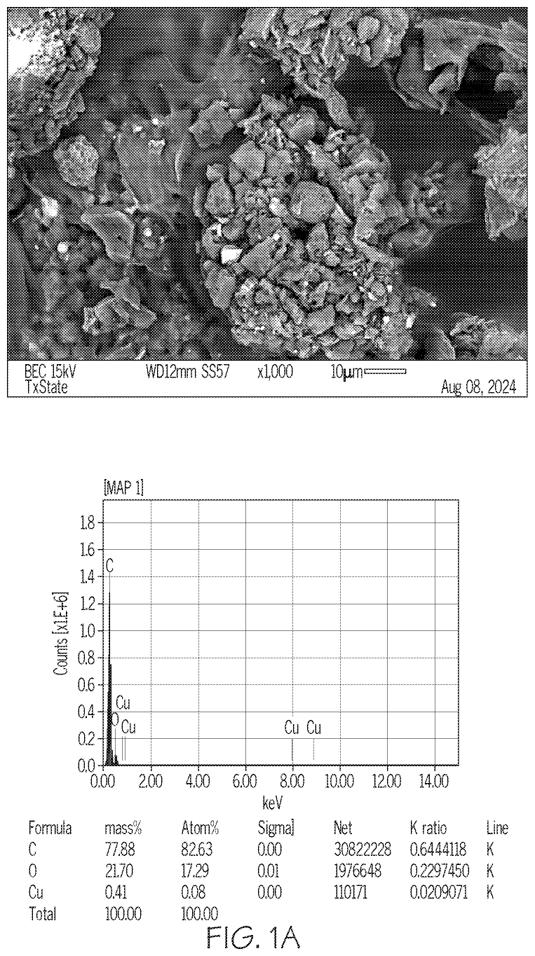

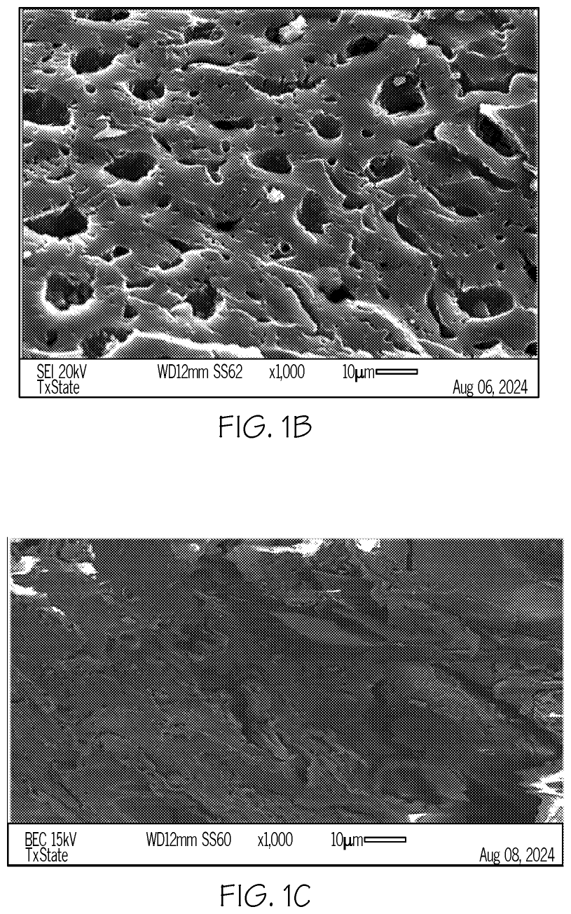

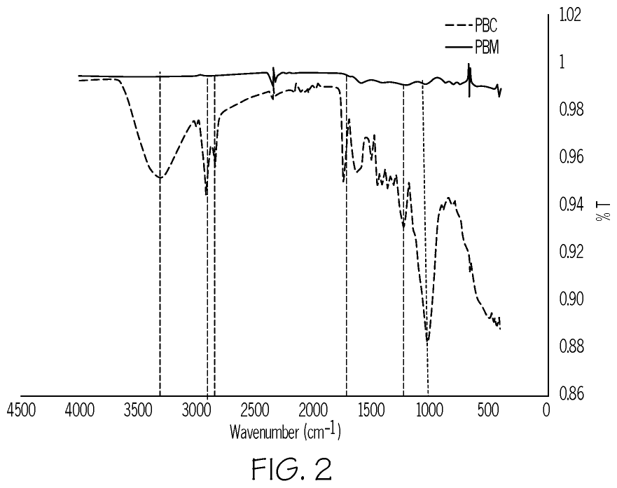

The scanning electron microscopy (SEM) images of the plum biomass (PBM) and PBC are shown in FIGS. 1A and 1B, respectively. The SEM image is representative of the porous structure of the biochar sample created during pyrolysis by the production of volatile matter. The SEM image in FIG. 1B also shows that the biochar has a lot of internal pores with pore diameters of more than 2 μm. Usually, higher internal pores contribute more active surface areas for adsorption, thereby resulting in higher efficacy of the adsorption performance of the absorbent.

The SEM image of the spent biochar is shown in FIG. 1C. The image shows the change in the porous structure of the PBC after adsorption of the dye molecules. Large channel-like structures which were generated on the surface of the biochar disappeared in the spent biochar sample, which clearly demonstrated the effective adsorption of three sets of dye solutions molecules.

Results from SEM with energy-dispersive X-ray spectroscopy (SEM-EDAX) show that PBC has 77.8 wt % of carbon and 21.8 wt % oxygen, respectively. It has been reported that lignin in biomass is highly influential in creating the porous structure of the biochar. The high carbon content (77.8 wt %) was a positive attribute of the prepared biochar.

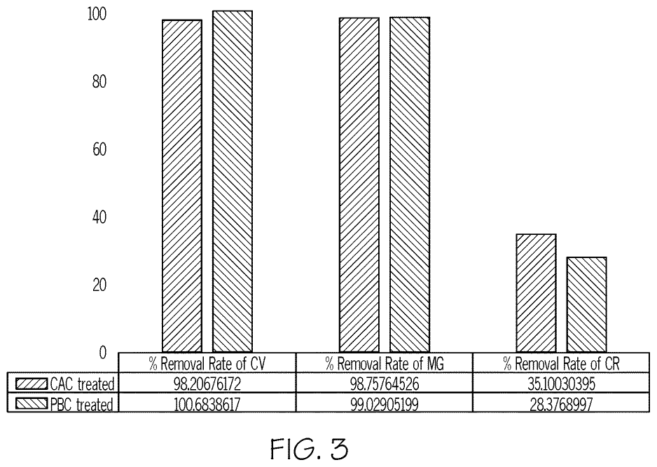

To identify functional groups in the PBC, and to characterize changes in biomass structure of the PBC, the Fourier-transform infrared (FTIR) spectrum of the PBC and starting plum biomass (PBM) was examined. As shown in FIG. 2, it is observed that PBM lacks distinct peaks, although some short peaks are observed at 2345 cm⁻¹, which can be ascribed to broad O—H stretching. Generally, these bands showed contributions from lignin, cellulose, and hemicellulose. A small peak around 1650 cm⁻¹ for PBM presented the CH and —C═H vibrations. A sharp distinct peak observed at 670 cm⁻¹ in the spectra of PBM is related to the C—H bending vibrations in lignin's aromatic rings.

Several distinct FTIR spectra were exhibited in PBC, which correspond to different functional groups. A broad peak at 3325 cm⁻¹ for PBC can be ascribed due to O—H stretching vibration associated with cellulose, lignin and phenolic compounds from lignin degradation. A very sharp band detected at 2925 cm⁻¹ and medium intensity peak at 2855 cm⁻¹ can be ascribed to C—H stretching vibrations associated with alkyl groups and aromatic bonds. The strong peak detected at 1735 cm⁻¹ has been linked to C═O stretching vibrations due to carbonyl groups. Medium diameter peaks around 1650 cm⁻¹ are related with C═O stretching vibrations of olefins and of aromatics. A short sharp peak at 1500 cm⁻¹ is clearly connected to C═C stretching of aromatic groups. The bands detected between 1455-1325 cm⁻¹ can are associated with C═C and C—H stretching in aromatic groups. The band at 1230 cm⁻¹ can be attributed to aldehydes, ketones, and ester groups of hemicellulose. A strong sharp peak seen at 1000 cm⁻¹ is associated with aromatic C—H plane bending vibration.

### Example 1.5. Comparative Studies Between Commercial Activated Carbon (CAC) and PBC

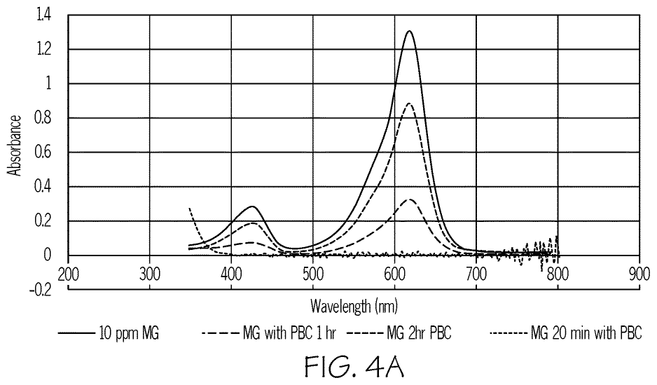

To explore the efficacy of PBC, a comparative study on the adsorption capacity of the developed absorbent PBC was also conducted under the optimum conditions (pH ~6.5; temperature: 25±2° C.; dye concentration: 10 ppm each; absorbent mass: 50 mg; volume of the dye solutions: 200 mL; contact time: 20 mins) with commercial activated carbon (CAC). For PBC, a maximum removal percentage of 100.68% was observed with CV, 99.03% with MG, and 28.38% with CR was observed using PBC (FIG. 3). For CAC, removal rates of 98.21% for CV, 98.76% for MG, and 35.10% for CR were observed (FIG. 3).

### Example 1.6. Contact Time Studies

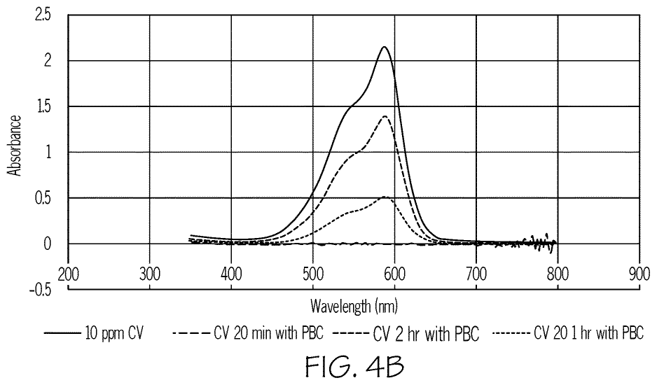

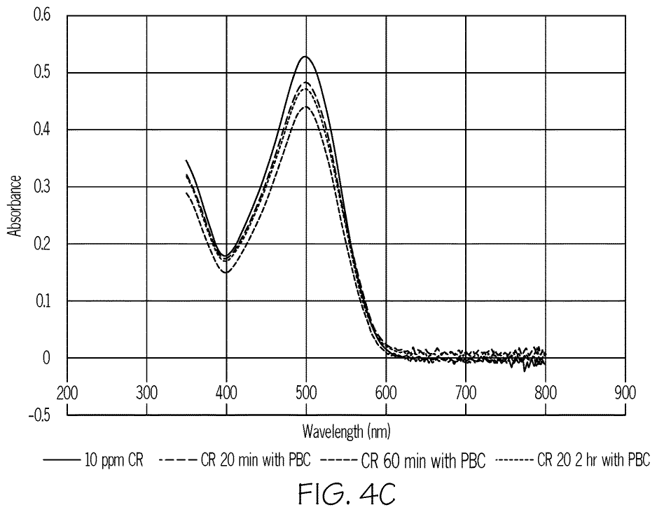

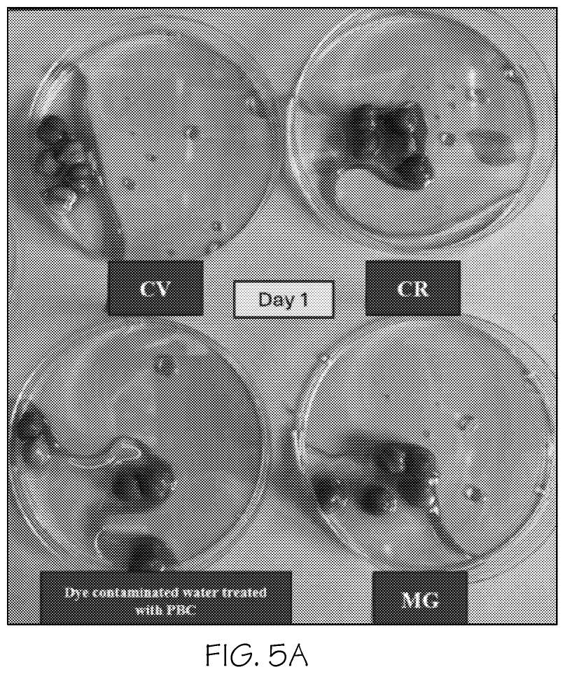

The effect of contact time on the performance of PBC for the removal of CV, MG and CR was examined in the range of 20 min, 60 min and 2 h using the following parameters: Temperature: 23±2° C.; initial concentration: 10 mg/L; pH ~6.5; and absorbent dose: 50 mg. The effect of contact time on the removal efficiency of metal ions and the dye is demonstrated in FIGS. 4A-4C. The percentage of the removal rate for CV, MG and CR increased as contact time was increased. The rate of removal percentage was very rapid for MG and CV dye solutions at the beginning until 20 minutes due to the availability of higher number of active functional groups and more vacant sites on PBC. The maximum removal percentage was observed at 1 hour for CR dye.

### Example 1.7. Toxicological Assessment of Dyes and Efficacy of PBC in Soil Amendment

The toxicological impact of CV, MG and CR was assessed on the seeds of chickpea lentil (Chana daal). The seeds were washed with DI water and placed in a 3.5-cm petri dish. Next, 3 ml of each CV, MG, and CR (10 mgL⁻¹) dye solutions were added to the seeds. The Petri dishes were incubated at room temperature. 3 ml of respective dye solutions and tap water were then sprayed for 5 consecutive days. Germination was recorded daily, and the experiments were carried out in triplicate.

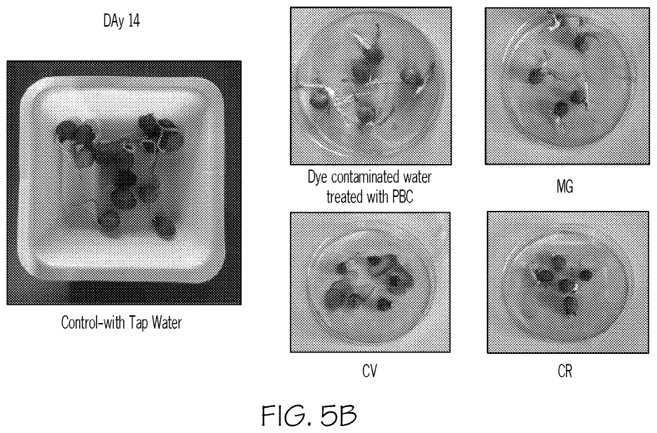

Tap water was taken as control and triplets of each concentration were maintained. The viability of seeds can be determined by performing a germination test, under controlled conditions to find the seeds that will germinate and develop into normal reproductively mature plants. The rate of germination (Equation 4) of the seeds were observed on day 1 (FIG. 5A) and day 14 (FIG. 5B), respectively. The International Seed Testing Association (ISTA) procedure was applied for the assessment of seed germination.

$$Germination ( \% ) = \frac{Chickpea seeds germinated}{Chickpea seeds taken for germination} \times 100 \qquad Equation 4$$

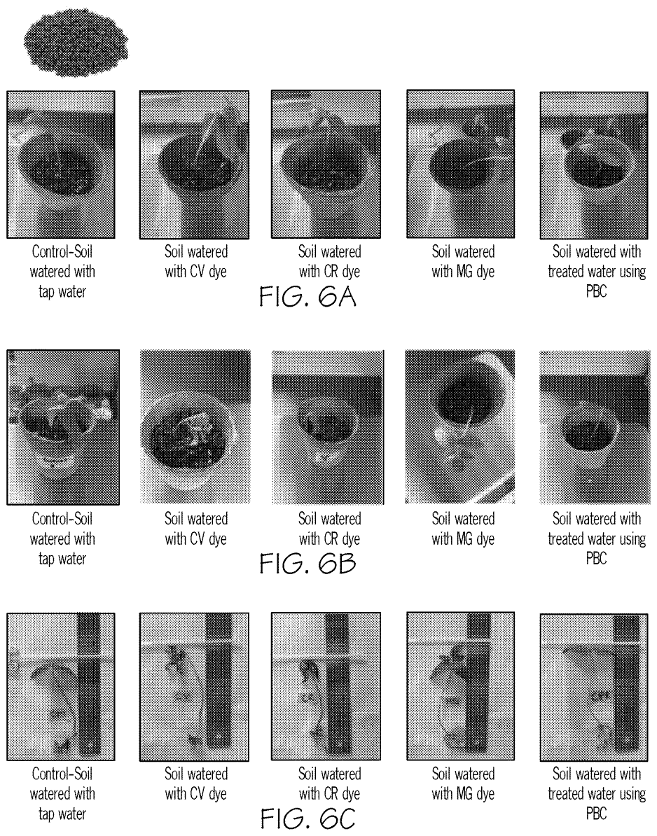

The germination of chickpeas using PBC treated dye contaminated water suggests that PBC plays a vital role in immobilization and adsorption of toxic contaminants, such as industrial dye, both from water and soil. As evident from FIGS. 6A-6C, the soil watered with treated water using PBC can sustain growth of mung beans while the soil watered with contaminated CV and CR dye solutions died on the eighth day. Thus, Applicant can conclude that PBC can also improve soil quality, by the removal of contaminants from water and thus increase crop yield. The developed sustainable biochar can also improve water and soil quality by the removal of toxic contaminants in minimal time and without using harsh chemicals.

### Example 1.8. PBC for Nutrient Enrichment in Soil Health and Manganese Removal from Water

Manganese is an essential micronutrient for soil and plant health. Crop quality and quantity are reduced owing to manganese insufficiency. As an essential micronutrient, manganese is vital for plant metabolism, contributing to photosynthesis, enzyme activation, and disease resistance. Adequate manganese in soil helps plants efficiently produce energy, supports chlorophyll formation, and improves resistance to environmental stress and diseases. Therefore, maintaining appropriate manganese levels in soil contributes to better plant growth, higher crop productivity, and overall soil fertility.

A manganese stock solution (50 mg/L) was prepared by dissolving manganese chloride in distilled water. Subsequently, 50 mg of PBC was added to 100 mL of the 50 mg/L manganese solution. The mixture was agitated using a mechanical shaker at 150 rpm for 60 minutes, while maintaining the pH in the range of 6.5-7.0 to facilitate adsorption of manganese onto PBC. The suspensions were filtered using filter paper to separate PBC particles from the solution. The filtrate was collected for manganese analysis using inductively coupled plasma mass spectrometry (ICP MS). The amount of manganese removed by PBC was calculated using equation 5.

$$Removal ( \% ) = \frac{( {C}_{0} - {C}_{f} )}{{C}_{0}} \times 100 \qquad Equation 5$$

In equation 5, C₀ is the initial manganese concentration (mg/L) and Cf is the final manganese concentration after biochar treatment (mg/L).

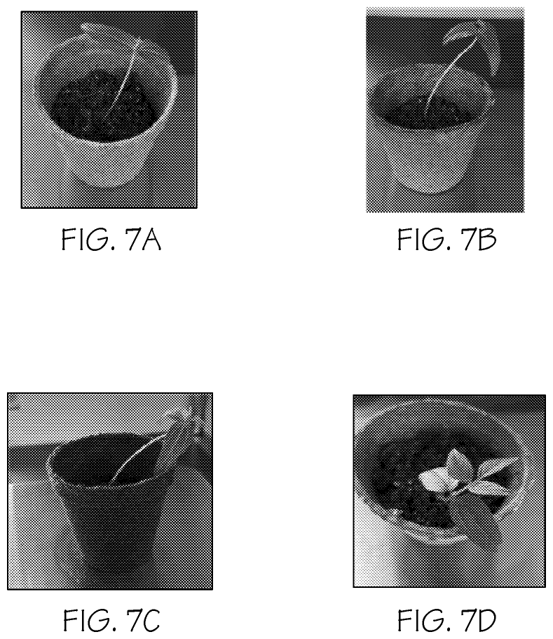

Additionally, plant growth test was conducted with two treatments using the same model plant moong lentil. Tiny pots were filled with equal amounts of soil. The manganese-enriched biochar was applied to a potted plant. Sprouted lentils were planted and growth of the plants were observed for 1-2 weeks (FIGS. 7A-7D). Plant growth was evaluated by monitoring leaf development and counting the number of leaves produced. At the end of 10th day, leaves were counted.

The ICP-MS results show that 49% of manganese were removed using PBC. At high concentrations, manganese may cause health issues, especially affecting the nervous system with long-term exposure. Plants grown in soil treated with manganese and PBC exhibited healthier and greener leaves, indicating improved nutrient availability and better soil health. Biochar enhanced the retention of manganese in the soil by increasing adsorption sites and improving nutrient holding capacity. As a result, plants were able to access manganese more efficiently, leading to improved leaf color and overall plant health. Thus, the results suggest that the manganese-loaded PBC could potentially be reused as a soil amendment to enhance soil nutrient content.

### Example 1.9. Summary

In summary, this example describes the use of PBC for the purification of wastewater streams and for use as a soil amendment. PBC was prepared without the use of chemical reagents via pyrolysis of plum pit waste (biomass) at a temperature of 500° C. for a period of one hour. The plum pits were obtained from local stores, ground, washed, treated with lemon juice, dried, and sieved to a particle diameter of between 230-300 μm. SEM analysis of PBC indicated it exhibited an extensive network of internal pores with pore diameters of more than 2 μm.

The PBC was evaluated in regard to its ability to remove three types of dyes: anionic CR and the cationic dyes CV and MG from an aqueous media, under a range of conditions, pH, initial dye concentration, contact time, and temperature.

50 mg of PBC was added to 10 mg/L (initial dye concentration) of the various dyes to create a solution, which was evaluated at a pH=6.5 for contact times ranging from 20-120 min at a temperature of 25±2° C. to determine the PBC dye adsorption capacities. As the contact times for solutions containing the CV and MG dyes and the PBC increased from 20 minutes to 120 minutes, the absorbance of the dye by the PBC increased. For the CR dye/PBC solution, the maximum absorbance was achieved at a contact time of 20 minutes, which decreased as contact times increased to one and two hours.

SEM analysis of the spent biochar after being exposed to the dyes indicated changes in the surface porous structure of the PBC after adsorption of the dye molecules indicative of dye capture by the PBC and a decrease in the materials pore network. A comparison of the adsorption capacities of the created PBC was performed versus a commercially available activated carbon (AC) product at a pH=6.5, a temperature of 25±2° C., dye concentrations of 10 ppm, a contact time of 20 minutes, and a PBC concentration of 50 mg. Results using the PBC showed a maximum dye removal percentage of 100.68% using CV, 99.03% using MG, and 28.38% with CR. Use of the commercial AC material showed a dye removal rate of 98.21% for CV, 98.76% for MG, and 35.10% for CR.

The toxicological effects of the three dyes, CV, MG, and CR, were assessed by adding them to tap water in concentrations of 3 ml (10 mgL⁻¹) to evaluate the seed germination process of chickpea lentil seeds, which was compared to a solution containing all three dyes and PBC. The seed germination process was evaluated over a period of 14 days. Photographic evaluations of the chickpea germination process indicated that after 14 days, the rate of seed germination was greater when PBC was used in the growth solution along with the dyes vs. solutions containing each of the three dyes without PBC, indicative of dye capture by the PBC.

Germination studies using Mung beans (lentils) showed that after 8 days of growth, the beans treated with both the CV and CR dyes died, while samples treated with the MG dye and the PBC-treated water survived. These observations were based on photographic evidence of the plant's leaf structure. Photographs of the 8-day-old mung bean root system showed that both the root structure of the CV and CR-treated plants were stunted, while the roots of the MG dye sample and the PBC-treated samples remained intact with significantly longer root systems.

Advantageously, the preferred pyrolysis temperature used to produce PBC (500° C.), is at a lower end of the accepted pyrolysis temperature range identified for biochar production (500° C.-700/800° C.), which would lead to decreased manufacturing costs. Moreover, as evaluated through testing, PBC achieved comparable CV and MG dye removal efficiencies as AC at a lower cost. Additionally, the use of plum pit biomass to create a PBC will create a new use for this discarded fruit waste.

Without further elaboration, it is believed that one skilled in the art can, using the description herein, utilize the present disclosure to its fullest extent. The embodiments described herein are to be construed as illustrative and not as constraining the remainder of the disclosure in any way whatsoever. While the embodiments have been shown and described, many variations and modifications thereof can be made by one skilled in the art without departing from the spirit and teachings of the invention. Accordingly, the scope of protection is not limited by the description set out above, but is only limited by the claims, including all equivalents of the subject matter of the claims. The disclosures of all patents, patent applications and publications cited herein are hereby incorporated herein by reference, to the extent that they provide procedural or other details consistent with and supplementary to those set forth herein.

What is claimed is:

1. A biochar derived from plum biomass.

2. The biochar of claim 1, wherein the plum biomass is selected from the group consisting of plum pits, plum peels, plum stones, plum pomace, or combinations thereof.

3. The biochar of claim 1, wherein the plum biomass comprises plum pits.

4. The biochar of claim 1, wherein the biochar comprises internal pore diameters greater than 2 micrometers.

5. The biochar of claim 1, wherein the biochar has a particle diameter between 200 micrometers and 300 micrometers.

6. The biochar of claim 1, wherein the biochar comprises at least 75 wt % carbon and at least 20 wt % oxygen.

7. The biochar of claim 1, wherein the biochar comprises functional groups selected from the group consisting of hydroxyl groups, carbonyl groups, olefinic groups, aldehyde groups, ketone groups, ester groups, aromatic groups, or combinations thereof.

8. The biochar of claim 1, wherein the biochar is loaded with one or more nutrients.

9. The biochar of claim 8, wherein the one or more nutrients are selected from the group consisting of manganese, nitrogen, phosphorus, potassium, calcium, magnesium, iron, zinc, copper, boron, molybdenum, or combinations thereof.

10. A method of maintaining or enhancing the growth of a plant or seed, said method comprising:
exposing a growth environment of the plant or seed to a biochar, wherein the biochar is derived from plum biomass.

11. The method of claim 10, wherein the growth environment is selected from the group consisting of water, soil, a hydroponic solution, or combinations thereof.

12. The method of claim 10, wherein the growth environment comprises one or more contaminants, wherein the biochar absorbs the contaminants, and wherein the contaminants are selected from the group consisting of dyes, metals, organic pollutants, carbon dioxide, or combinations thereof.

13. The method of claim 10, wherein the plant or seed is selected from the group consisting of cereals, legumes, oilseeds, fruits, vegetables, crops, or combinations thereof.

14. The method of claim 10, wherein the biochar is loaded with one or more nutrients, and wherein the biochar releases the nutrients to the plant or seed.

15. The method of claim 14, wherein the one or more nutrients are selected from the group consisting of manganese, nitrogen, phosphorus, potassium, calcium, magnesium, iron, zinc, copper, boron, molybdenum, or combinations thereof.

16. The method of claim 10, wherein the biochar comprises internal pore diameters greater than 2 micrometers.

17. A method of removing contaminants from an environment, said method comprising:
exposing the environment to a biochar, wherein the biochar is derived from plum biomass, and wherein the biochar absorbs the contaminants in the environment.

18. The method of claim 17, wherein the environment is selected from the group consisting of an aqueous environment, a gaseous environment, a solid environment, or combinations thereof.

19. The method of claim 17, wherein the environment comprises an aqueous environment selected from the group consisting of water, wastewater, water streams, industrial effluents, or combinations thereof.

20. The method of claim 17, wherein the contaminants are selected from the group consisting of dyes, metals, organic pollutants, carbon dioxide, or combinations thereof.

21. The method of claim 17, wherein the biochar comprises internal pore diameters greater than 2 micrometers.

22. A method of making a biochar, said method comprising:
pyrolyzing plum biomass to form the biochar.

23. The method of claim 22, wherein the plum biomass is selected from the group consisting of plum pits, plum peels, plum stones, plum pomace, or combinations thereof.

24. The method of claim 22, wherein the plum biomass comprises plum pits.

25. The method of claim 22, wherein the pyrolysis is conducted at temperatures of less than 600° C.

26. The method of claim 22, wherein the pyrolysis is conducted at a heating rate of at least 10° C./min.

27. The method of claim 22, further comprising loading the biochar with one or more nutrients.

28. The method of claim 27, wherein the nutrients are selected from the group consisting of manganese, nitrogen, phosphorus, potassium, calcium, magnesium, iron, zinc, copper, boron, molybdenum, or combinations thereof.
